(19) United States
(12) Patent Application Publication
(10) Pub. No.: US 2022/0373690 A1
(43) Pub. Date: Nov. 24, 2022

(54) ATMOSPHERIC SENSOR USING PROGRAMMABLE TIME-GATED DETECTION APERTURE

(71) Applicant: CONNECTSIX LLC, CLEARWATER, FL (US)

(72) Inventors: Scott Allen Samson, Safety Harbor, FL (US); Lawrence Clair Langebrake, St. Petersburg, FL (US)

(21) Appl. No.: 17/664,272

(22) Filed: May 20, 2022

Related U.S. Application Data
(60) Provisional application No. 63/191,330, filed on May 21, 2021.

(51) Int. Cl. G01S 17/894; G01S 7/481; G01S 17/95; G01S 7/4865

(52) U.S. Cl. CPC G01S 17/894; G01S 7/4816; G01S 17/95; G01S 7/4814; G01S 7/4865

(57) ABSTRACT

An optical instrument for determining the distance to a target. The instrument includes a light source for emitting a pulsed light beam and a lens responsive to the light beam and projecting the light beam on the target. The instrument also includes an imaging lens responsive to a reflected beam from the projected light beam on the target and a TOF sensor including a photodetector array having an array of detector elements, where each detector element includes an FET switch and a capacitor for storing charge, and where the imaging lens focusing an image of the projected light beam on a group of the detector elements in the array. Processing electronics control the light source and processing of the image of the projected beam on the array, where the processing electronics determine a time from when the light beam is emitted and the image of the projected beam is created.

### CROSS-REFERENCE TO RELATED APPLICATIONS

This application claims the benefit of the filing date of U.S. Provisional Application 63/191,330, titled, LIDAR Rangefinder With Programmable Detection Aperture, filed May 21, 2021.

### BACKGROUND

### Field

This disclosure relates generally to an optical instrument for determining the distance to a target and, more particularly, to an optical instrument for determining the distance to a target that employs a time-of-flight (TOF) detector array and a programmable detection aperture.

### Discussion of the Related Art

Light detection and ranging (LIDAR) instruments optically measure the range of a target from the instrument. LIDAR instruments use a pulse, series of multiple pulses or periodically varying amplitude waveforms of light emitted from a laser to illuminate the target, and a high-speed detector to record the received light reflected off the target. Because light travels at a finite speed (approximate 3×10⁸ m/s in air), measuring the beam's total transit time from the laser to the detector yields range information. One application of a LIDAR instrument is for measuring the distance to particles, such as aerosols, precipitation, clouds, etc., in the atmosphere.

Ceilometers are LIDAR instruments that determine the height and presence of cloud layer(s) and other particles in the air. Because the presence of clouds impacts human vision, airports often employ ceilometers to provide an estimate of the cloud height and coverage over the airport. Known ceilometers generally include a pulsed laser or light emitting diode (LED) whose light is collimated using a lens or mirror to illuminate a cloud or backscattering particles in the sky with a projected laser spot. Light photons reflected off the cloud are focused by a focusing lens onto a plane near the focal length of the focusing lens, thus forming an image of the spot on the cloud. A fast photodetector is positioned to collect a substantial portion of the spot image. Electronics including electrical amplifiers convert the photocurrent from the photodetector into voltage, which is sampled by a high-speed analog-to-digital converter (ADC) and fed into a signal processing system. The electronics also produce signals to generate the outgoing laser pulse or pulses. The temporal amplitude and arrival time of photons onto the photodetector is dependent on a number of factors, most significantly, the speed of light and the backscatter efficiency of particles in the path of the laser beam as it transits from the instrument to the cloud and back. Often, only a few photons (or less than one, on average, per pulse, of outgoing laser pulse) is collected and received by the photodetector.

Known ceilometers use photodetectors with internal gain (10s, 100×s or 1000×s) such as avalanche photodiodes (APD) or APDs operating in a Geiger (high gain, photon-counting) mode to amplify photon signals above readout electronic noise levels. Depending on the desired range of detection, the focal length of the lens is chosen so that when the distance between the laser and the collimating lens is adjusted, the outgoing laser beam can be approximately collimated with minimal divergence. Because of finite laser dimensions, lens imperfections and diffraction, the outgoing laser beam spreads somewhat. The magnification of the photodetector varies approximately (when range>>focal length) as the ratio of the focal length to range-to-target. The design selection of these photodetectors is a trade-off between near and far-field performance and a balance of signal and noise. Smaller detectors receive less ambient light (background noise) signals, yet a too-small detector will lose some of the desired reflected laser signal, which may only be a few photons/pulse on average during normal operation, and be susceptible to mis-alignment during manufacturing or use. Large near-field ceilometer beam returns can saturate the detector or produce non-linear results, which requires compensation/correction and additional system characterization, leading to costly development, calibration, and system cost. Large-signal performance degradation can result in non-linear gain in detectors, for example, APDs, which are typically AC-coupled and have gain that varies vs reverse bias current and temperature.

The focused image size of the beam spot on the cloud varies with size and position over the range of use because of variable magnification and accompanying defocus versus optimum focus. Known APD or high gain detectors (e.g. SPAD˜APDs operated in Geiger photon counting mode) use large bias voltages to generate internal gain of generated photoelectrons. These detectors are chosen because they have the property of internal gain, which amplifies photon-generated electrons within the detector, prior to adding readout amplifier noise. This gain process introduces some excess noise, i.e., gain is not perfect and is non-linear. Also, the gain will amplify received ambient light signals and thermally-induced electrons in the photodetector.

Another known type of sensing array being used for wide field-of-view LIDAR instruments employ 1-D or 2-D arrays of APD or single-photon avalanche diodes (SPAD), which have very high photoelectric gain per pixel, sometimes exceeding a million electrons per received photon. To enable 3D range imaging, the SPAD arrays are coupled with high-speed amplifiers and analog-to-digital circuitry to sample the light profile in both space and time. These continuously sampled systems can operate in ‘flash’ mode, whereby a single light pulse is emitted by a light source and the light reflected off of objects subsequently detected in time and space on the sensor, and the received signals decoded (for time and brightness) to produce a depth map (2-D or 3-D) of the scene being imaged and actively illuminated.

Existing ceilometer designs are typically optimized for long range performance, for example, measuring clouds up to or exceeding 12,500 feet from the instrument. These designs produce inefficient optical overlap between the projected laser spot and the focused image on the photodetector at shorter range. The range to complete overlap between laser illuminating and the detector's field-of-view is typically 100 meters or more. For coaxial ceilometer systems that employ a shared/concentric emitter and detector beam path, the overlap between the outgoing and incoming beams is higher than biaxial ceilometer systems that have side-by-side emitter and receiver lenses. However, low magnification and defocus issues at near range results in only a fraction of the light being collected by the photodetector. For biaxial systems, the same defocus issues also occur. In addition, the image of the laser spot is laterally offset from the center of the photodetector. The offset varies with range, and detector size and is typically chosen large enough to account for the varying offset over the application range.

One characteristic of known ceilometer designs is that the emitters and detectors that they use are small, i.e., a few microns to a few hundred microns in each dimension. Thus, the system must be precisely aligned and maintained rigidly over the instrument's operational temperature and environmental (shock, motion, etc.) use-range. This high precision adds complexity, cost and weight to the system design and components, thus making the system prone to misalignment and replacement of finite lifetime components (laser, detector) more complex, challenging and costly.

Based on the foregoing, there is a need for a ceilometer photodetector that can detect fast (few nS) signals, introduce little noise during detection intervals, and have an optimally matched overlap between the illuminating laser spot and receiver area at all detection ranges of interest.

Photodiode arrays that use inexpensive silicon integrated circuits have been employed in consumer, industrial and scientific cameras. Over time, additional unique capabilities have been incorporated into the integrated circuit that accompanies or is integrated within the imaging chips. Though silicon is the most common material used to date, other materials (e.g. having an infrared response) can be used to produce imaging arrays (and cameras).

One new class of imaging arrays is gated time-of-flight (TOF) sensors that have been developed for providing 3D scene imaging. A TOF sensors' 3D scene imaging capability is realized by illuminating scenes using wide field-of-view illumination and approximately matched imaging lens and custom imaging chips. Some of these known TOF sensors include programmable fast nS-gated low-leakage transistors and include one or more charge accumulation capacitors per pixel in which to collect the gated photoelectrons produced by photons impinging on each photodiode. Notably, this sample-and-hold photon detection and charge accumulation is performed prior to electronic amplification. Also notable is the capability to have multiple accumulation periods per pixel before the capacitor array is read out as a frame, and the capability to adjust timing of the gating relative to a repetitive timing signal.

To enact 3D imaging, one or more delayed snapshots of reflected short-pulses (typically a few to 10 s of nanoseconds of light is received. Using post-processing of two or more range snapshots, the range is estimated by measuring relative amplitude of returns vs time and knowledge of the approximately constant speed of light. The range estimation over the scene can be performed using processing internal or external to the sensor chip.

Some known sensors have two or more charge accumulation capacitors per pixel, each configured to capture two or more of these few-nS-snapshots of received photons. The algorithms used to determine range compare the relative amplitude between the two (or more) time snapshots (phases) and knowledge of the outgoing light pulse to estimate range to target. A third charge accumulation capacitor may be supplied and used to measure ambient light levels when no laser light is expected to be received. Some sensors may include timing generation, control signals and amplifiers, analog to digital converters and digital communications capabilities integrated on the same chip.

### SUMMARY

The following discussion discloses and describes an optical instrument for determining the distance to a target. The instrument includes a light source for emitting a pulsed light beam and a lens responsive to the light beam and projecting the light beam on the target. The instrument also includes an imaging lens responsive to a reflected beam from the projected light beam on the target and a TOF sensor including a photodetector array having an array of detector elements, where each detector element includes a current regulating switch and a capacitor for storing photon-induced charge, and where the imaging lens focusing an image of the projected light beam on a group of the detector elements in the array. Processing electronics control the light source and processing of the image of the projected light beam on the array, where the processing electronics determine a time from when the light beam is emitted and the image of the projected light beam is created on the array so as to determine the distance to the at least one target. The processing electronics include an electronically adjustable aperture that selects a number of the detector elements, a size of the selected detector elements, a position of the selected detector elements on the array and a shape of the selected detector elements.

Additional features of the disclosure will become apparent from the following description and appended claims, taken in conjunction with the accompanying drawings.

### BRIEF DESCRIPTION OF THE DRAWINGS

FIG. 1 is an illustration of a ceilometer system for determining the distance between a ceilometer instrument and a target in the sky;

FIG. 2 is a schematic diagram of a TOF sensor array employed in the ceilometer instrument shown in FIG. 1;

FIG. 3 is a schematic diagram of one of the detector elements in the sensor array shown in FIG. 2.

FIG. 4A is an illustration of a photodetector array showing a reflected spot from a target at close range;

FIG. 4B is an illustration of the photodetector array showing a reflected spot from a target at mid-range;

FIG. 4C is an illustration of the photodetector array showing a reflected spot from a target at long range;

FIG. 5 is an illustration of the photodetector array showing a reflected spot from a target at all of close range, mid-range and long range;

FIG. 6 is an illustration showing a number of laser pulses and capacitor charge accumulation over one frame for high photon flux;

FIG. 7 is an illustration showing a number of laser pulses and capacitor charge accumulation over one frame for low photon flux;

FIGS. 8A-8C show a photodetector and a spot projected thereon from a moving cloud;

FIGS. 9A and 9B show a photodetector and a spot and ambient light projected thereon from a moving cloud;

FIG. 10 is an illustration of an optical atmospheric sensing system for determining forward scatter from particles in the atmosphere for visibility and present weather detection purposes;

FIG. 11 is a graph with time on the horizontal axis that illustrates the temporal nature of light traveling in time within the system shown in FIG. 10; and

FIG. 12 is an illustration of a transmissometer system for measuring optical attenuation within a sampling volume.

### DETAILED DESCRIPTION OF THE EMBODIMENTS

The following discussion of the embodiments of the disclosure directed to an optical instrument for determining the distance to a target that employs a TOF detector array and a programmable detection aperture is merely exemplary in nature, and is in no way intended to limit the disclosure or its applications or uses.

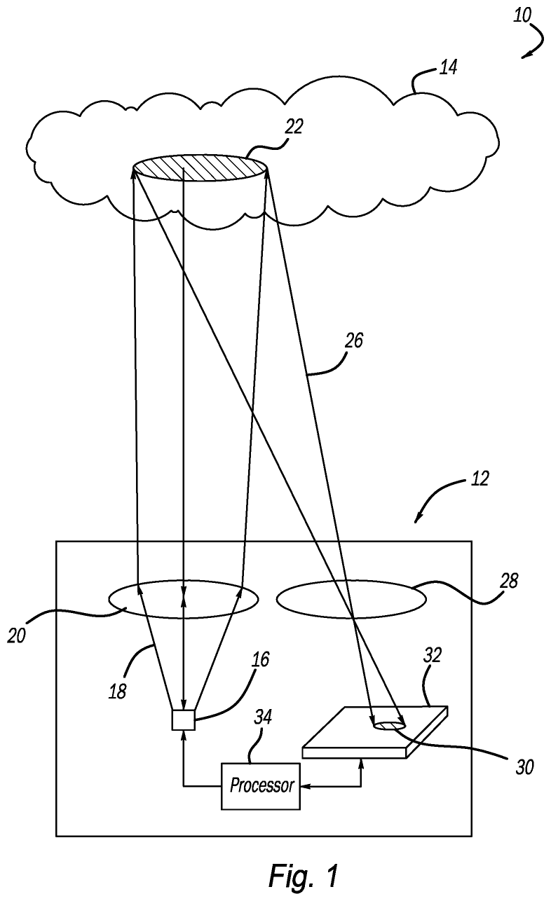

FIG. 1 is an illustration of a ceilometer system 10 including a biaxial ceilometer instrument 12 that determines the distance to a target 14 in the sky, such as a cloud or other various atmospheric particles. The instrument 12 includes a laser 16 suitable for the purposes described herein that emits a pulsed laser beam 18 that is collimated by a collimating lens 20 and projected as a laser spot 22 on the target 14. In alternate embodiments, the laser can be other types of light sources, such as an LED, that emit pulsed light beams. A portion of a reflected beam 26 from the laser spot 22 on the target 14 is directed back towards the instrument 12 and is focused by a focusing lens 28 as an image 30 of the spot 22 on a gated TOF sensor 32, which does not require, but may benefit from, avalanche gain. The lateral position of the image 30 on the sensor 32 is not required to be centered on the optical axis of the lens 28. More specifically, offsetting the sensor 32 relative to the optical axis of the lens 28 may be beneficial because clouds and atmospheric particles closer to the ceilometer instrument 12 are still focused onto one portion of the sensor 32, but far away atmospheric particles are also imaged onto a separate region on the sensor 32, as will be discussed in detail below. Beam generation and image processing electronics 34 controls the generation of the laser beam 18 and processing of the image 30 detected by the sensor 32.

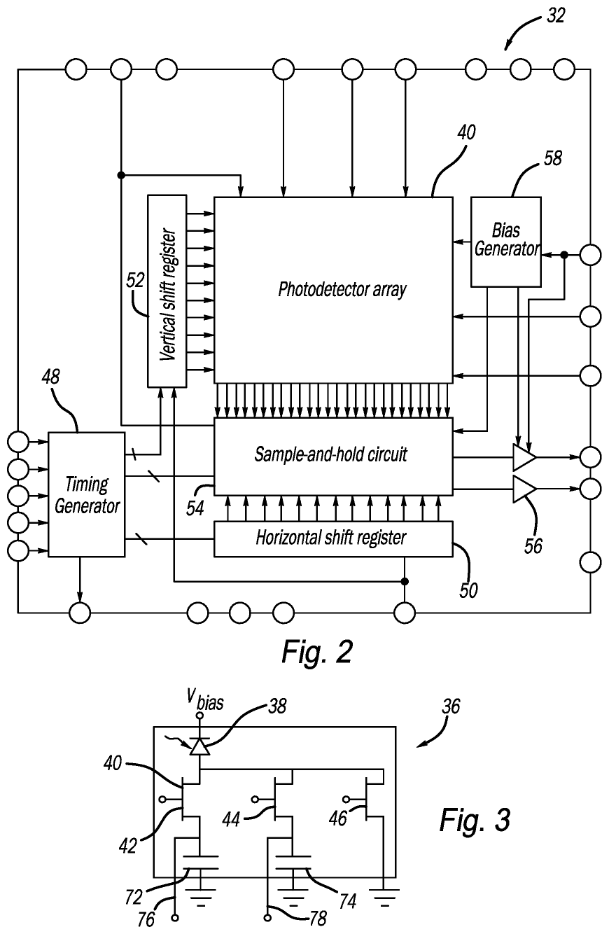

FIG. 2 is a schematic diagram of the TOF sensor 32 separated from the instrument 12 showing one possible design. The sensor 32 includes a photodetector array 40 having an array of pixels or detector elements, for example, 104×80 pixels. FIG. 3 is a schematic diagram of one detector element 36 in the array 40, and includes a photodiode 38, FET switches 42, 44 and 46 and capacitors 72 and 74. When the FET switch 42 is biased at its gate terminal, photocurrent is integrated over a time-gated sampling or frame and collected by the capacitor 72 and when the FET switch 44 is biased at its gate terminal, photocurrent is integrated over a time-gated frame and collected by the capacitor 74. Similarly, the FET switch 44 is provided to integrate a second period of photocurrent onto the capacitor 74. The FET switch 46 dumps unwanted photocurrent. Lines 76 and 78 direct the integrated photocurrent to a sample and hold circuit 54. The frames can be very precisely controlled in the nanosecond range, thus providing an electronically programmable position and range detection aperture. For each frame and depending on the time the pixels have been biased on, the accumulated charge for all of the pixels is output from the sensor 32 as a representation of what pixels accumulated charge and how much. This process can be repeated at different times between outgoing laser pulses 18 and switching on the FET switches 42, 44 and 46 to detect targets at different distances from the instrument 12.

A timing generator 48 controls the timing of the laser 16 for firing the light pulse 18, a horizontal shift register 50 and a vertical shift register 52 that selectively output the stored charge in the capacitors 72 and 74 to the sample and hold circuit 54 to be output through buffer amplifiers 56 to the processing electronics 34. A bias generator 58 provides a bias voltage to the sample and hold circuit 54, the photodetector array 40 and the amplifiers 56. Thus, the TOF sensor 32 can be configured to capture an image of the atmosphere at a particular range by using a short, for example, 100 nS, snapshot in time by delaying the charge storage gating of the photodetector array 40 at appropriate times (nanoseconds to several microseconds) relative to emitting the pulsed beam 18 from the laser 16.

In other embodiments, the capacitively stored and sampled range-snapshot detectors can be replaced with more electronically demanding time and space-sampled photo-amplified (APD or SPAD) detector arrays. In such cases, all depths and spatial details of interest can be sampled, and the ideal subsections of the array 40 vs time/depth can be used to extract cloud height for each pulse.

Measurement of one or more distances from the instrument 12 can be accomplished for each frame of collected photons generated by the sensor 32 during a sample period by using one or more of the time-gated charge storage capacitors 72 and 74. Because the photodetection by the array 40 is ‘turned on’ at a specific range, large numbers of photons from ambient light or significant scatter near the ceilometer instrument 12 do not saturate the array 40, as may occur with traditional ceilometer detection schemes. The tradeoff is that generally more frames may be acquired to produce a full picture of cloud depth over the full range of interest. The gating and number of laser pulses can be optimized depending on the signal expected or experienced. The TOF sensor 32 can be operated up to a few hundred frames/second, though for optimum collection, a large fraction of a second or many seconds of exposure per frame may be desirable.

For example, three of the storage capacitors of the type similar to the capacitors 72 and 74 in the TOF sensor 32 could collect three range bins, such as at 100, 200 and 300 feet range, in one frame using, for example, 100 laser pulses. Then another frame could detect reflected light from 400, 500, and 600 feet range in one frame using, for example, 200 laser pulses. The ranges of interest could be generated in such a manner until the full ceilometer range is measured, where, for example, the last frame at 12300 feet, 12400 feet and 12500 feet could be acquired by accumulating photoelectrons from, for example, 5000 laser pulses. The ranges and number of pulses discussed above is only an example and may be adjusted based on ambient light, environmental conditions, accuracy, signal-to-noise (SNR), etc. Generally, further ranges will result in a range squared reduction in received signal so more pulses may be beneficial at longer ranges.

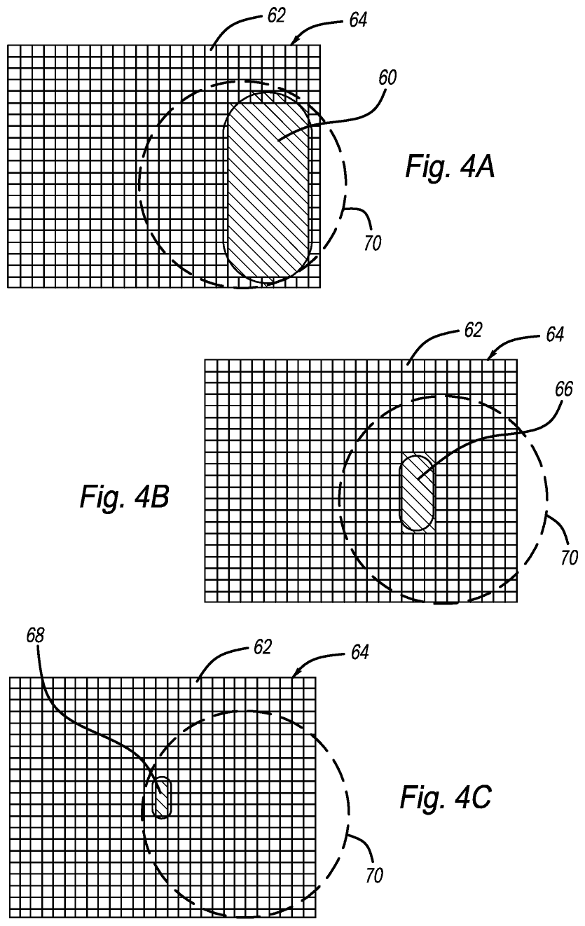

Often, lasers have an asymmetric beam profile, such as an ellipse, due to the laser cavity geometry and differing divergence from the laser 16 in each direction. Also, the collimated spot typically has a non-symmetric intensity profile, such as a Gaussian or multimodal and elliptical shape. The instrument 12 has an electronically adjustable aperture that provides for the selection of a number of detector elements not only in the right size and position, but also including an ideal shape on the photodetector array 40, so that as much ambient light as possible may be rejected while receiving as much laser signal as possible to maximize SNR and hence, range. In other words, the instrument 12 allows for a programmable electronic and dynamic selection of only a specific portion or multiple portions of the TOF sensor 32 for recording the reflected beam power. For example, for close range detection, the reflected photons from the laser spot 22 can be focused by the lens 28 to a large sized spot 60 over a cluster of pixels 62 to the right side of a photodetector array 64 representing the array 40, as shown in FIG. 4A. For medium range detection, the reflected photons from the laser spot 22 can be focused by the lens 28 to a medium sized spot 66 over a cluster of the pixels 62 nearer to the center of the photodetector array 64, as shown in FIG. 4B. For long range detection, the reflected photons from the laser spot 22 can be focused by the lens 28 to a small sized spot 68 over a cluster of the pixels 62 at the center of the photodetector array 64, as shown in FIG. 4C. This is in contrast to the fixed-area single-element fast detector shown by dotted circle 70 used in a conventional ceilometers design process, where a somewhat larger detector area is chosen to allow function at varying ranges.

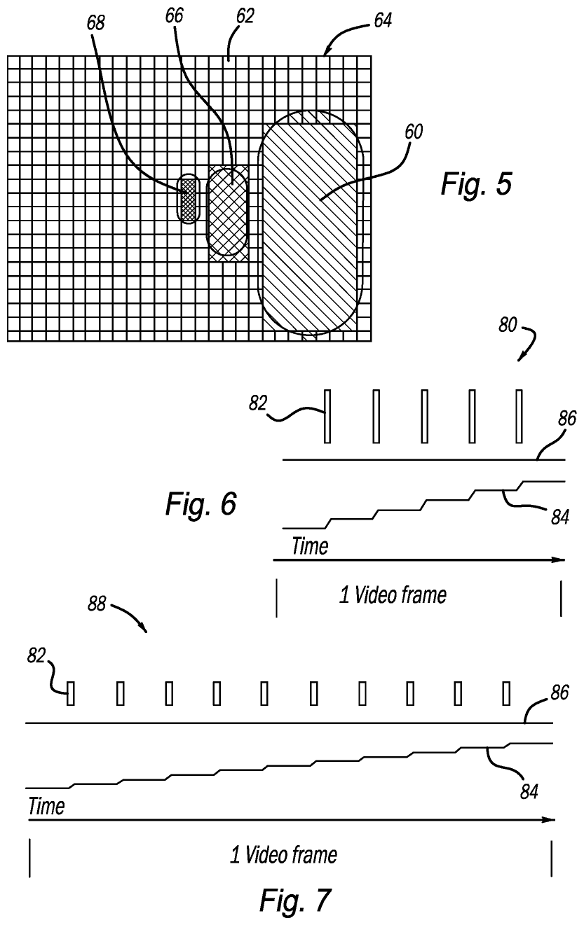

In another embodiment, longer beam exposures or variable frame times will allow multiple target ranges to be imaged simultaneously. This is illustrated in FIG. 5 showing all of the spots 60, 66 and 68 being simultaneously imaged on the photodetector array 64. The close range spot 60 reaches the array 64 before the medium range spot 66 and before the long range spot 68. When the pixels FET switches are gated on long enough to capture return signals from all desired ranges, yet short enough to substantially reject ambient light, the presence and concentration of particles at each range to the targets can be determined from the position and amplitude of signals across the array 64.

A-priori during design and manufacture or during operational knowledge of the laser position and profile may be used to define the desired region(s) of the array 64 to include in the analysis process. This can be done at each range of interest so as to optimize the speed of measurement and/or the SNR or to correct for movement or misalignment of the optics. Further, the pixels in the selected TOF sensor region of interest on the array 64 can be added or averaged, either linearly or using numerical weights, which will produce a signal with better SNR over a single non-ideal detector area. Adding and averaging pixels improves SNR by approximately the square root of N, and adding and averaging over a number M or consecutive frames further improves SNR by the square root of M, where N is the number of pixels being used to average the received reflected laser signal and is M the number of frames averaged. The total improvement is expected to be the square root of (M*N). Notably, the optimum variable detection region may be found somewhere on the mm-sized photodetector array 64, even at very close ranges of a few meters and out to the longest range of interest. This is in contrast to conventional ceilometers that have a 100 m or so range to full overlap of the illuminating beam and its image on the detector.

The benefits of the instrument 12 discussed above include a simplified design, construction and maintenance of ceilometers or rangefinders. Because of the electronically adjustable aperture, precise alignment of the laser and detector axes and component locations do not need to be precisely maintained over operational use, i.e., time, temperature, vibration, transport, etc. Moreover, this simplifies and reduces the cost of manufacturing and replacement of consumable parts, such as the diode laser. Reduced high-voltage and high-speed analog electronics, sampling and processing when using the integrated TOF sensor 32 reduces system complexity, noise injection and cost. The dynamically adjustable detection aperture vs range results in improved effective size and shape of detection area, which results in a large improvement in SNR, which is especially important at longer ranges. The instrument 12 provides a large reduction in overlap range, i.e., few m vs 100 m+, which is important for characterization of near-earth boundary layer, accurate computation of cloud parameters (backscatter) in varying atmospheric conditions, and providing low-level cloud height information, which is especially useful for smaller aircraft including autonomous aerial systems (UAS) that often fly closer to the earth's surface. Binning, i.e., summation or weighted summation, of multiple pixels and frames within the array 40 further improves SNR by approximately the square root of (N*M).

Other advantages can be obtained by intentionally misaligning the outgoing and imaging axes or spatially separating the outgoing and imaging axes. For example, longer detection integration durations and non-parallel illumination and imaging axes, i.e., oblique illumination may be used to ‘smear’ the image of the outgoing laser pulse reflecting off of particles or clouds spatially across the photodetector array 40, with different range distances imaged onto different areas of the array 40 simultaneously. This could be useful to more quickly find the approximate height of high-reflectance objects (thick, lower level clouds) where the additional ambient light produced during such longer exposures may not overly reduce the SNR of the system.

Other advantages can be obtained by using multiple illuminating sources emitting light either simultaneously or at different time intervals, wavelengths or polarizations, which are focused onto different areas of the sensing array. For example, eye-safety or reliability may be enhanced by utilizing two or more light sources in common or multiple illuminating optical paths. Since the TOF sensor 32 and the processor 34 are capable of defining multiple electronically adjustable detection apertures for each frame, additional information or depths can be captured per each frame and improvements in SNR can be achieved through multi-spot averaging.

Some TOF sensors have the capability to read the charge storage capacitors 72 and 74 in a non-destructive readout (NDR) manner during a frame integration time. By reading the signal prior to an expected end-of-frame interval, the exposure can be stopped (stop emitting pulses) and read out the accumulated charge voltage prior to detector saturation occurring. This NDR can be used to detect and stop the gated accumulation prior to pixel charge storage capacitor saturation. For example, LIDAR systems typically send and measure 100s or 1000's of pulses in order to get SNR>1, but high target return strength or high ambient light levels could result in charge storage capacitor saturation prior to the signal from 1000 pulses being accumulated.

An example of using an NDR to vary the number of recorded pulses based on ambient light and signal relative to detector saturation levels is illustrated in FIGS. 6 and 7. Particularly, FIG. 6 is an illustration 80 showing five laser pulses 82 and the accumulated capacitor charge 84 therefrom over one frame for a high photon flux, where line 86 represents the maximum number of electrons, i.e., capacitor well depth, before capacitor saturation. FIG. 7 is an illustration 88 showing ten of the laser pulses 82 and the accumulated capacitor charge 84 over one frame for a low photon flux.

The instrument 12 can use an NDR to improve SNR and measure background light levels when the TOF sensor 32 may be incapable of simultaneously measuring a pixel during a non-exposed period of time and during laser illumination, where the gating delay for transistors does not sufficiently encompass the microseconds delay required for ceilometers over their full range. Some TOF sensors that are optimized for near-range TOF 3D scenes may not have sufficient delay capabilities between triggering laser and recording any ambient light reading and laser illuminated light readings. Thus, a choice may have to be made to measure either ambient light or the laser illuminated signal for each frame. Due to temporal variation of the imaged object (e.g. a variable-reflectance cloud quickly passing the TOF pixels imaging it), this ambient light variation may produce temporal noise that may be large and thus cannot be effectively differentiated from the laser-reflected signal.

The slope of the signal increase during NDR can be used to measure the slope of the signal during frame acquisition. During portions when the laser 16 is not firing, the slope is due to ambient light and any dark current. When the laser 16 is firing, the slope is due to both the range-reflected signal and the ambient and dark current signal. Thus, over several thousand pulse cycles, the background light levels may be sampled many more times than by waiting to capture the next un-illuminated frame to measure background light level.

The instrument 12 can use one or several sub-frame intervals where at least one sub-frame interval allows collection of ambient light only and at least one sub-frame interval allows collection of the desired beam return as well as the ambient light signal. Subtracting the ambient light only signal from the combined signal, and computing the slope from the multiple averages will yield an ambient light subtracted signal with better rejection of fast-varying ambient lighting conditions than taking sequential frames with laser pulsing and then laser off (ambient only).

Additionally, the instrument 12 can use multiple readouts of the stored charge-signal either during or after accumulation to reduce the effect of amplifier noise through averaging, which is expected to decrease noise by the square root of S, where S is the number of re-samples used in signal averaging. Since the TOF sensor 32 can produce hundreds of NDR's per second, the readout noise can be reduced by more than 10× at 1 Hz frame rates by using multiple NDR read averaging.

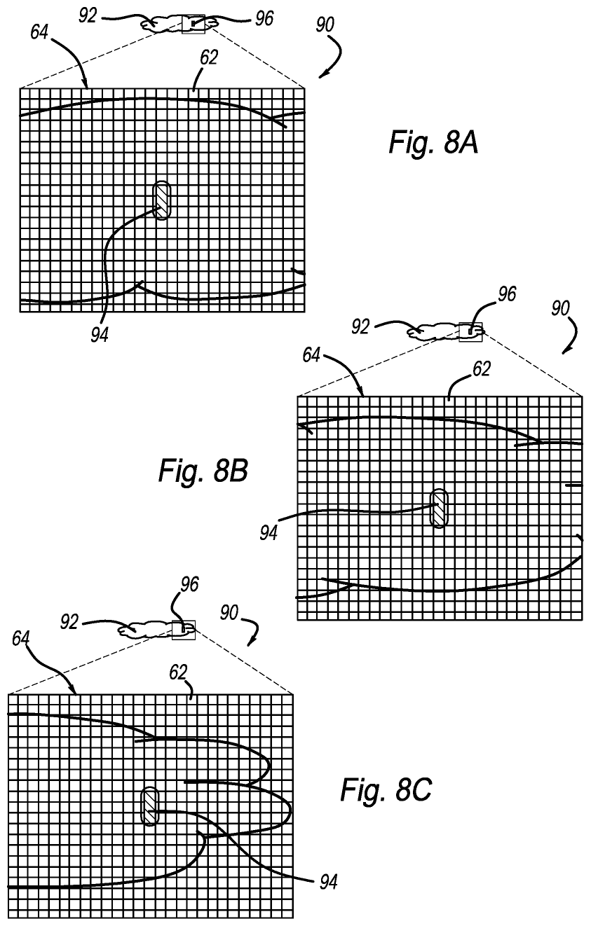

Since the TOF sensor 32 is capable of imaging 2D scenes (3D scenes if the active illumination and synchronized gating are used over a portion of the cloud/target), using sequential frames in time can be used to determine cloud velocity, i.e., ‘winds aloft’ of the clouds or particles. This embodiment is illustrated in FIGS. 8A-8C showing an illustration 90 of a cloud 92 moving over time and being imaged by the instrument 12. At times T1 (FIG. 8A), T2 (FIG. 8B) and T3 (FIG. 8C) an imaged beam spot 94 on the array 64 of a laser spot 96 on the cloud 92 is at the same location on the array 64, but each imaged beam spot 94 is from a different location on the cloud 92. The height of the cloud 92 is determined using the above described methods to determine range and thus knowledge of the imaging system magnification (Mag˜R/f2, where R is the range and f₂ is the focal length of the imaging lens 28). This magnification can be used to determine the effective size of the pixel being projected onto the cloud 92 as:

Sₚᵢₓₑₗ=TOF pixel dimension*Mag[meters/pixel].

An algorithm compares the captured frame at one time to one or more previous time(s). Using well-known image processing algorithms, the vector (direction and rate) of motion, vₚᵢₓ=#pixels/s can be determined.

Using both of the pixel velocity vₚᵢₓ and an effective pixel size Sₚᵢₓₑₗ, measurements of the 2D wind velocity of winds aloft can be precisely determined as:

V_{winds}=vₚᵢₓ*Sₚᵢₓₑₗ [m/s].

This winds aloft and motion of cloud cover information can be very useful for a number of applications. Examples include meteorological studies and weather forecasting, safety or efficiency enhancement for aircraft (both conventional and unmanned aerial systems: UAS/drones), site investigations and predictive modeling for wind power generation, predictive modeling for solar power generation sites, etc.

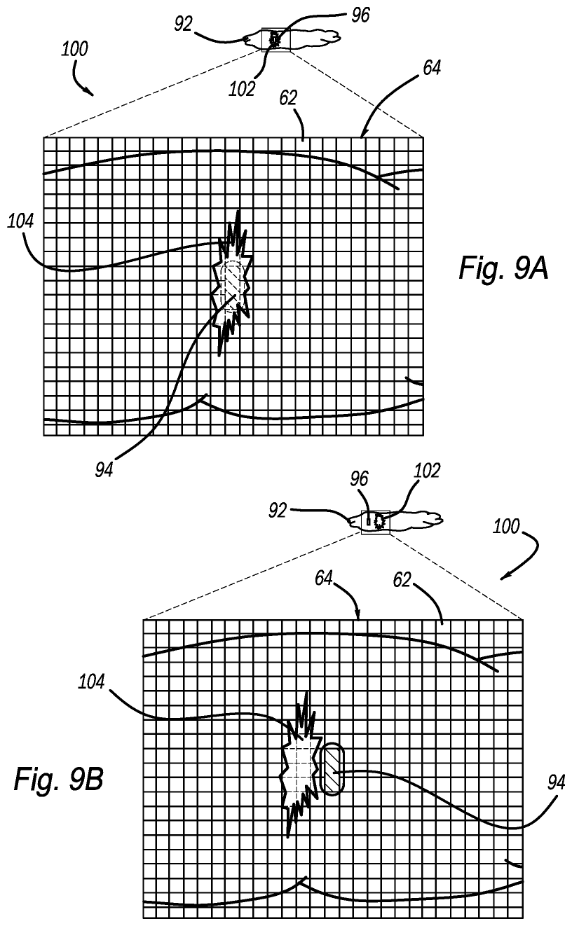

An alternate method for estimating ambient light levels during a frame integration can be done using spatio-temporal information about the ambient light scene, i.e., brightness level and velocity within the TOF camera's field of view). More specifically, the instrument 12 can also use the movement of ambient light vs time information to estimate and remove the influence of ambient light at the laser-sampling area. This embodiment is illustrated in FIGS. 9A and 9B showing an illustration 100 of the cloud 92 moving over time. The instrument 12 images a spot 102 of ambient light in the cloud 92 on the array 64 as imaged ambient light spot 104. At time T1 (FIG. 9A) the imaged ambient light spot 104 is over the imaged beam spot 94 and at time T2 (FIG. 9B) the imaged ambient light spot 104 is adjacent to the imaged beam spot 94 as it moves across the array 64.

The instrument 12 uses the following process to remove the influence of ambient light from the actively selected pixel region of interest on the array 64, i.e., the optimum collection of at-range pixels. First, the process samples the optimized image region covering the laser beam pulses reflected off of the cloud 92 during one or more frames. This includes the contribution from the laser beam 18 and from ambient light at that space and time T1. The process then samples ambient light in the pixels outside of the area covered by the laser beam 18 during a sequence of frames, T1-T2. The background light at the optimized sampling region for laser light can be estimated by using the ambient light images from times T1 and T2 and the 2D velocity of the ambient scene, discussed above with reference to FIGS. 8A-8C, and digitally repositioning the ambient light scene where it would have been at time T1 on the sampling area. The laser-only reflected light at time T1 can be determined by subtracting the spatially-transposed background light image from the optimized image region.

This process has the advantage of allowing D depth ranges to be captured simultaneously, where D is the number of the unique charge storage capacitors 72 and 74 per pixel in the TOF sensor 32, whereas using the capacitor 74 for ambient light level storage reduces the number of ranges measured/frame to M−1. Additionally, this algorithm/method is suitable for compensating for ambient light in the TOF sensor 32, which has only one charge storage capacitor 72. It is noted that although the background light signal can be subtracted, the shot noise contribution (˜sqrt(ambient)) to the SNR cannot be completely removed, but can be improved by multi-frame or sub-frame averaging, discussed above.

A modification of the instrument 12 can be used to measure optical forward or backscatter from particles in the atmosphere for visibility and weather detection. This measurement is the basis of modern visibility and present weather sensors such as those used on roadways and airports. Improvements to these known systems can be provided to reduce the complexity and cost of system design and increase sensitivity, precipitation identification, and ambient light or external object interference in the measurement.

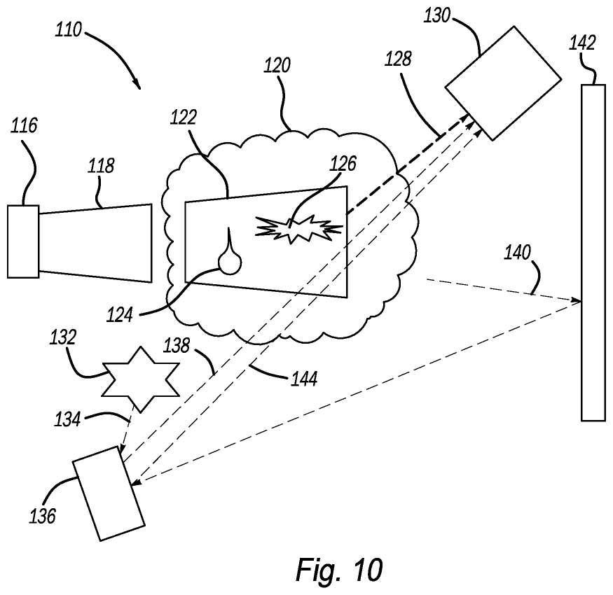

FIG. 10 is an illustration of an optical atmospheric sensing system 110 for determining optical forward scatter from particles in the atmosphere for visibility and present weather detection. The system 110 includes an emitter 116 that transmits light pulses 118 into the atmosphere 120. After a brief delay equal to the distance from the emitter 116 divided by the speed of light, the light pulse 118 travels to a position within a desired sampling volume 122 within the atmosphere 120 containing gas, aerosols, and, possibly, larger particles such as rain 124 and snow 126, for example. A portion 128 of the light pulse 118 is scattered off of these elements towards a receiver 130 including a single pixel or two-dimensional TOF integrating array of the type discussed above, where the portion 128 of the light pulse 118 is detected. Light 134 from other sources 132, such as streetlights and the sun, can be reflected off of objects 136 and be directed as ambient light 138 towards the receiver 130. Some of the initial light pulse 118 may pass as light 140 through the desired sampling volume 122 and be reflected off of an object 142 and the object 136, and produce multiply-reflected light 144 which also can enter the receiver 130.

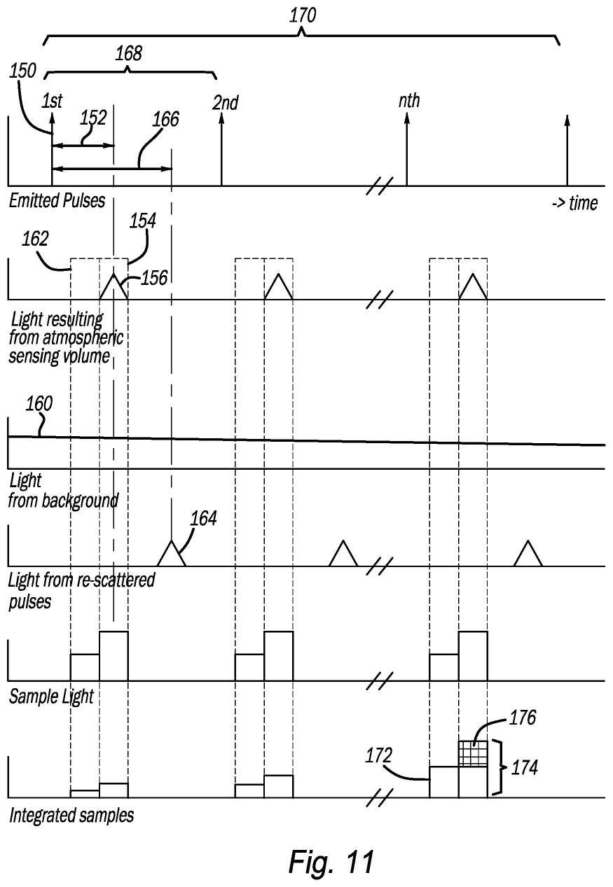

The system 110 can be designed to remove the effects of ambient light and re-scattered light as described from the desired measurement of scattering off of particles within the sampling volume 122. FIG. 11 is a graph that illustrates this process, where time is on the horizontal axis. FIG. 11 illustrates the temporal nature of light traveling in time within the system 110 for the emitting pulse 118, light resulting from the sampling volume 122, the ambient light 138, the reflected light 144 from re-scattered pulses and the portion 128 of the light pulse 118. Pulse light 150 leaves the emitter 116 and travels for a brief time until the light 150 enters the sampling volume 122, which scatters some of the light 150 into the receiver 130. The transit time 152 between the emitted pulsed light 150 and the received light is determined by the transmitter-receiver distance geometry and the speed of light. Inside the receiver 130, during one pulsed light sample window 154 of time, the scattered light pulses 156 caused by illuminated particles from the desired measuring atmospheric volume is sampled. This sampled light is added to any instantaneous ambient light 138 in the view of the receiver 130. The contribution of ambient light can be largely, but not completely, reduced by including an optical bandpass filter with a passband encompassing a large portion of the emitted wavelengths, prior to the optical detector in the receiver 130. The remaining solely ambient light 160, i.e., the light without the contribution of the pulsed light 150, is sampled during another time window 162. The time window 162 may be before or after the pulsed light sampling window 154, but should preferentially be performed when light is representative of ambient light conditions, but away from a time when the pulsed light 150 can reach the receiver 130. Preferentially, its time should be close enough in time to the pulsed light sampling window 154 to sample substantially the same amount of ambient light level that is added during that pulsed light sampling window 154. It may be noted that the time interval between the sampling windows 154 and 162 are preferentially very short (a few nanoseconds) so that ambient light levels, even from nearby modulated ambient light sources such as those emanating from even high-frequency (up to a few kHz) man-made lights are constant between the sampling windows 154 and 162.

Other undesirable light sources, such as those that may be produced by pulsed scattered light 164 from the objects 136 and 142 can produce light 144 that enters the receiver 130. This scattered light transits a longer optical path and thus enters the receiver 130 at a later time 166 relative to the sampling window 154. Thus, through the fast-sampling method, re-scattered light is rejected in the ambient light sampling window 162 or the sampling volume sampling window 154.

The bottom traces of FIG. 11 illustrate the light signals sampled during a series of many light pulse cycle 168 and integrated samples of ambient and sample volume light over one to n pulses of light during a frame cycle 170. The vertical axis of the integrated samples plot is de-magnified to illustrate the beneficial integration of ambient light and sample-volume light over many cycles of pulsing and measuring. During each cycle 168, additional electrons produced by photons reaching the receiver 130 are separately accumulated in the sampling windows 154 and 162. After the n pulses, the integrated signals produced by ambient light samples 172 and pulsed light samples 174 are electrically read out. The average scattering light value 176 from the sampling volume 122 may be accurately determined by subtracting the time-averaged ambient light 172 from the ambient plus pulsed-light 174. The value of the average scattering is linearly-relatable to a beam optical extinction coefficient a. The extinction coefficient can be related to the more commonly-reported (eg. on roadways or at airports) meteorological optical range (MOR), or visibility, by the relation 3.0/a, where the value 3.0 may be a constant, vary slightly from the 3.0 value, or be a function of extinction coefficient to more closely relate the optical scattered visibility estimate to a reference optical transmissometer. The choice in relating the two values may be determined by intended use and regional requirements.

Particles in the atmosphere are influenced by gravity, wind and uplifting air currents. Larger particles such as rain and hail fall at a faster rate than smaller mist particles or snow. The presence and rate of occurrence of these particles is often desirable information to the end user. Often the type and rate of particles are known as ‘present weather’. Usually, smaller particles are much more prevalent than larger particles. Small particles may not be individually apparent to imaging systems such as a visibility and present weather sensor, for example, the system 110, yet may contribute a measurable scattering signal 128. Larger particles may be resolved by the present weather's internal focusing optic and a two-dimensional sensor. The sampling volume 122 in this embodiment for the visibility and present weather sensor is preferably interrogated by multiple light pulses to obtain a sufficient integrated signal indicative of atmospheric visibility which exceeds system noise.

The system 110 provides a multiply-exposed image during the frame cycle 170 of any particles within the sampling volume 122. Multiply-exposed moving particles are apparent as smeared object images on the receiver 130. The size, shape, direction and magnitude of particle movement within the smeared image of the particle can be used to preferentially estimate its type (eg. rain, snow, hail) rate of occurrence, and can indicate wind-induced phenomenon, such as blowing snow vs. falling snow. It may be known to those versed in the production of visibility and present weather sensors that the size and rate of fall of particles can be beneficial information to determine the type of precipitation (mist, rain, snow, hail). The temporal measurement of particle size and quantity, both within a single integrated image frame, and over time (eg. seconds or minutes) and tens to thousands of image frames can be used to estimate precipitation intensity (light, moderate, heavy) and accumulation rates. The exposure and accumulation of multiple pulses of light prior to readout using a TOF sensor is preferential to other methods (such as normal CMOS/CCD imaging methods) that could be envisioned by those versed in the art, because the data processing and readout rate (frame rate) in the present invention is markedly reduced, and effects of ambient and scattered light can be readily removed using the aforementioned methods. For slower-moving particles that may dwell in the sampling volume 122 for a longer period of time, the frame-frame estimation of particle velocity can be used to advantage.

The system 110 can use a single element TOF detector in the receiver 130 to measure the scatter off of small and larger particles from time to time. Smaller suspended particles produce a semi-constant scattering signal in the receiver 130, whereas a larger falling or blowing particle produces a temporary increase in signal as the particle transits the sampling volume 122 and a drop in signal as it passes the sampling volume 122. By measuring the magnitude and duration of the alternating signal, the size and speed of a particle can be estimated from the single element TOF detector. The TOF detector is advantageous in that it can quantify larger particles in the sampling volume concurrently. The aforementioned multiple non-destructive readouts within a frame can be used to limit the number of light pulses being integrated so as to prevent saturation of a single detector or on portions of the array detector.

Often for atmospheric transmission measurements, a transmissometer instrument consisting of a light source mounted on a rigid pole directs light to a receiver mounted on a rigid pole some distance (10-100 m) away. In such a configuration, due to atmospheric scattering and absorption, i.e. attenuation, the light reaching the receiver is reduced from the light being received during a best-visibility day. The transmission T=e\hat{ }(−C*z), where C is the attenuation coefficient [m⁻¹] and z is the distance between the transmitter and receiver. In many transmissometer installations two instruments with different baselines between transmitters and receivers (z₁, z₂) are used. The shorter baseline provides a more accurate transmissometer reading during low-visibility conditions and a longer baseline provides a more accurate transmissometer reading during high visibility conditions. Often the transmissometer system is supplemented by a forward-scatter visibility sensor, such as the type previously described, which provides better long range (several km) accuracy. Dirt on the optical windows, mechanical deflection of the optics (wind and temperature) and variations in emitter intensity can result in degraded measurement and need for frequent servicing to clean and re-align optics. These traditional transmissometer instruments are costly to install and expensive to operate.

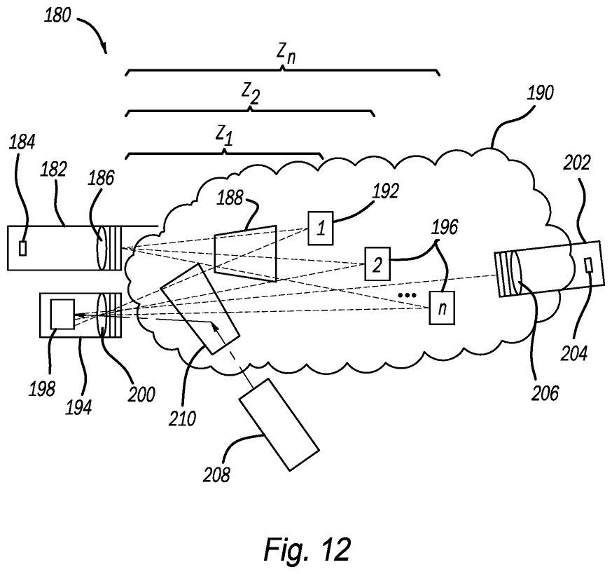

In another embodiment, the emitter 116 and the receiver 130 in the system 110 may be configured into a back-scattering geometry similar to the cloud height detection geometry, but for the purpose of measuring horizontal atmospheric transmission. FIG. 12 is an illustration of a transmissometer system 180 for measuring light attenuation within a sampling volume 190 illustrating this embodiment. The system 180 includes a transmitter 182 having a pulsed light source 184, such as an LED, and a lens 186 that projects a light pulse 188 towards an environment 190. The light pulse 188 transits the environment 190 where it is slowly attenuated by the molecules, aerosols and precipitation within the transit volume. Upon reaching an object 192 at a certain distance z₁, some of the light is backscattered through the environment 190 and collected by a receiver 194. The object 192 can preferentially be an efficient diffuse reflector (e.g. a ‘white’ surface at the interrogating wavelengths) or a more optically-efficient object such as a retroreflector, which can improve reflection efficiency of the light pulse 188 back toward the receiver 194 by several orders of magnitude compared to a diffuse reflector. One or more additional reflective objects 196 within the field-of-view of the transmitter 182 and the receiver 194 at one or more distance ranges (z₁, z₂, . . . , zₙ) may be utilized, for the benefit described below.

Notably, by using a short-pulsed light source and time-gated receiver, a backscattered signal from the aerosols and precipitation near the transmitter/receiver pair are received by the receiver 194 sooner than the light pulses which return after reflecting from the longer distance through the environment 190 to the object 192 and back. Similarly, objects at different ranges produce temporally separated optical returns. Within the receiver 194, which may include a single pixel or pixelated array 198 of time-of-flight detectors, the temporally and/or spatially separated targets are focused by a lens 200 and can be individually resolved. Measuring the time-of-flight gated transmitted signal while excluding the prior arriving backscattered signal and the ambient light, the beam attenuation can be differentiated from the near emitter backscatter component.

This time-gated measurement of optical transmission allows the use of reflective targets versus more complex separated transmitter and receiver pairs, which may not have methods to decouple the backscatter from attenuation signals if they used a convenient reflecting arrangement with co-located source and receiver pair. Although adding some complexity, a separate pulsed transmitter 202 having a pulsed light source 204 and a lens 206 located at or separate from the objects 192 and 196, and which directs its light toward the receiver 194 could be used instead of or in addition to the co-located transmitter 182 and the reflective objects 192 and 196. Such a configuration might be desirable if very long baseline distances are preferred as the reflected signal off very distant reflective target may produce poor signal levels. This orientation would require a means to precisely synchronize the source pulsing with the receiver's gated reception, such as an RF pulse, cable, or an optical trigger signal produced by either the transmitter 182 or the receiver 194.

Using the aforementioned ambient-light suppression techniques provided by the TOF sensors in the system 110, natural or man-made ambient light sources and scattering objects can be removed from the beam attenuation measurement.

Preferably the pixelated array 198 of time-of-flight detectors is a 2D array of pixels, so that the known, and fixed regions for each target within the scene are both spatially and temporally distinguishable, which produces a better signal relative to the noise sources. These individual regions can be analyzed, and an attenuation coefficient Cₙ can be computed for each of the n targets as:

Cₙ=−1*ln(Eᵣ/(bₙ*Eₒ)/(2*zₙ),

where Eₒ is the projected optical energy over the integration cycle, zₙ is the distance between transmitter/receiver and the nₜₕ target (with light traveling through the range two times going from transmitter to target to receiver), Eᵣ is the received optical energy, and bₙ is a number that accounts for all factors associated with optical energy reduction in the system 180, to include for example, beam spreading, non-uniform scene illumination, object reflectivity, and the 1/zₙ² dependence of intensity reduction from the transmitter 182 to the receiver 194 and back, optics transmissivity, etc. The bₙ coefficients can be determined in the field by comparison to a calibration reference (eg. using a calibrated forward scatter sensor's attenuation value and computing bₙ to fit the measured results), or by mature system design and factory calibration.

In a spatially homogenous atmosphere, the computed attenuation coefficients (C₁, C₂, . . . Cₙ) for each of the objects 192 and 196 should be equal. Variation in (C₁ . . . Cₙ) can be indicative of an inhomogenous atmosphere, mechanical misalignment or attenuation cause by the protective window optics. In each instance, the multiple measurements can provide the user a metric of attenuation coefficient accuracy, a means to null common-mode loss (eg. window transparency) or to alert the operator of a need for maintenance. Window transparency decrease is a common cause of erroneous transmissometer measurements and servicing. Because the common-use optics loss is linearly applied to all of the object coefficients (b₁-bₙ), and beam transmission is exponentially related to the ranges (zₙ), the optics loss can be quantified by iteratively applying loss value to the separate transmissometer Cₙ measurement until a best match between the C₁ . . . Cₙ results.

The receiver 194 may also be a common receiver for a forward scatter measurement, such as the system 110. This may be accomplished by providing an additional transmitter 208 in the system 180. In this manner, the receiver 194 may be used to receive optical signals for transmissometer measurements when using the transmissometer transmitter 182 and the objects 192 and 196, or the transmitter 202, and also receiving optical signals from the forward scattering measurement of a separate sampling volume 210 when using the forward scatter transmitter 208. Such an arrangement can be useful to reduce system cost for a runway visual range (RVR) system, and the forward scatter meter can provide a built-in technique to calibrate the transmissometer object coefficients (bₙ). Inexpensive field portable calibration objects are well known in the visibility instrument field, and these are suitable for calibrating the forward scatter meter portion of a combined or separate visibility instrument.

Common measures to reduce the likelihood of moisture or dirt from landing, condensing or freezing onto the optics of the transmitters 182, 202 and 208 and the receiver 194 may be used to extend the reliability and operability of the described visibility, present weather and transmissometer systems in all weather conditions. This may include windows, hoods, heaters, blowers and the like. Additional features commonly used in optical systems to measure contamination affecting the optics can also be utilized in the system.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. An optical instrument for determining the distance to at least one target, said instrument comprising:
a light source for emitting a pulsed light beam;
a lens responsive to the light beam and projecting the pulsed light beam on the at least one target;
an imaging lens responsive to a reflected beam from the projected light beam on the at least one target;
a time-of-flight (TOF) sensor including a photodetector array having an array of detector elements, where each detector element includes at least one time-gated capacitor for storing charge, said imaging lens focusing an image of the projected light beam on a group of the detector elements in the array; and
processing electronics for controlling the light source and processing the image of the projected light beam on the array, said processing electronics determining a time from when the pulsed light beam is emitted and the image of the projected beam is created on the array so as to determine the distance to or strength of the at least one target.

2. The instrument according to claim 1 wherein the processing electronics include an electronically adjustable aperture that selects a number of the detector elements, a size of the selected detector elements, a position of the selected detector elements on the array, a shape of the selected detector elements and a weighting of the selected detector elements.

3. The instrument according to claim 2 wherein the electronically adjustable aperture selects certain detector elements on different regions of the array depending on the distance to the at least one target.

4. The instrument according to claim 3 wherein the electronically adjustable aperture selects a relatively large number of the detector elements at one location on the array for a relatively close target, selects a relatively medium number of the detector elements at another location on the array for a relatively medium range target, and selects a relatively small number of the detector elements at another location on the array for a relatively far target.

5. The instrument according to claim 1 wherein the at least one target is multiple targets at different distances from the instrument and wherein the instrument determines the distance to the multiple targets and the targets scattering strength simultaneously from position and magnitude of the imaged projected light beam on the array.

6. The instrument according to claim 1 wherein the TOF sensor reads charge from the capacitors in a non-destructive readout (NDR) manner.

7. The instrument according to claim 1 wherein the TOF sensor and the processing electronics process multiple sequential images of the projected light beam on the array as the at least one target moves in time so as to determine a velocity of the at least one target.

8. The instrument according to claim 1 wherein the TOF sensor and the processing electronics process multiple sequential images of the projected light beam on the array and an ambient light spot on the at least one target as the at least one target moves in time so as to remove the ambient light from backscatter measurements.

9. The instrument according to claim 1 wherein an axis of the reflected beam is angularly and laterally offset from an axis of the emitted light beam.

10. The instrument according to claim 1 wherein the at least one target is selected from the group consisting of a cloud, rain, snow, ice, particles and aerosols.

11. The instrument according to claim 1 wherein the instrument is a ceilometer.

12. The instrument according to claim 1 wherein the instrument determines forward scatter from particles in the atmosphere for visibility and/or present weather detection purposes.

13. The instrument according to claim 1 wherein the instrument measures light attenuation within a sampling volume.

14. The instrument according to claim 1 wherein the light source is a laser or and an LED.

15. An optical instrument for determining the distance to at least one target, said instrument comprising:
a light source for emitting a pulsed light beam;
a lens responsive to the pulsed light beam and projecting the light beam on the at least one target;
an imaging lens responsive to a reflected beam from the projected light beam on the at least one target;
a sensor including a photodetector array having an array of detector elements, said imaging lens focusing an image of the projected light beam on a group of the detector elements in the array; and
processing electronics for controlling the laser and processing the image of the projected light beam on the array, said processing electronics including an electronically adjustable aperture that selects a number of the detector elements, a size of the selected detector elements, a position of the selected detector elements on the array and a shape of the selected detector elements, said processing electronics determining a time from when the pulsed light beam is emitted and the image of the projected light beam is created on the array so as to determine the distance to the at least one target.

16. The instrument according to claim 15 wherein the electronically adjustable aperture selects certain detector elements on different regions of the array depending on the distance to the at least one target.

17. The instrument according to claim 15 wherein the electronically adjustable aperture selects a relatively large number of the detector elements at one location on the array for a relatively close target, selects a relatively medium number of the detector elements at another location on the array for a relatively medium range target, and selects a relatively small number of the detector elements at another location on the array for a relatively far target.

18. The instrument according to claim 15 wherein the at least one target is multiple targets at different distances from the instrument and wherein the instrument determines the distance to the multiple targets and the targets scattering strength simultaneously from position and magnitude of the imaged projected light beam on the array.

19. The instrument according to claim 15 wherein the light source is a laser or and an LED.

20. An optical instrument for determining an atmospheric condition in a sampling volume in the atmosphere, said instrument comprising:
a light source for emitting a pulsed light beam into the sampling volume;
a time-of-flight (TOF) sensor including a photodetector array having an array of detector elements, where each detector element includes at least one time-gated capacitor for storing charge, said sensor receiving scattered light from the sampling volume; and
processing electronics for controlling the light source and processing the scattered light on the array, said processing electronics including an electronically adjustable aperture that selects a number of the detector elements, a size of the selected detector elements, a position of the selected detector elements on the array and a shape of the selected detector elements so as to process the scattered light and determine the condition.

21. The instrument according to claim 20 wherein the instrument determines forward scatter from particles in the sampling volume for visibility and/or present weather detection purposes.

22. The instrument according to claim 20 wherein the instrument measures light attenuation within the sampling volume.
